(19) United States
(12) Patent Application Publication
(10) Pub. No.: US 2017/0177288 A1
(43) Pub. Date: Jun. 22, 2017

(54) APPARATUS AND METHOD FOR TRANSITIONING CONTENT BETWEEN DISPLAYS

(71) Applicants: Theodore Charles Wingrove, Plymouth, MI (US); Michael Eichbrecht, Farmington Hills, MI (US); Kyle Entsminger, Canton, MI (US); Andrew DeScisciolo, Canton, MI (US); James Joseph Kornacki, Dearborn, MI (US)

(72) Inventors: Theodore Charles Wingrove, Plymouth, MI (US); Michael Eichbrecht, Farmington Hills, MI (US); Kyle Entsminger, Canton, MI (US); Andrew DeScisciolo, Canton, MI (US); James Joseph Kornacki, Dearborn, MI (US)

(21) Appl. No.: 14/976,610

(22) Filed: Dec. 21, 2015

(51) Int. Cl. G06F 3/14; G02F 1/1335; G09G 3/32; G02F 1/1333

(52) U.S. Cl. CPC G06F 3/1446; G02F 1/13336; G02F 1/133524; G02F 1/133526; G09G 3/32; G09G 2380/10; G09G 2340/0478; G09G 2340/14

(57) ABSTRACT

The present disclosure generally relates to an apparatus and method for transitioning content between multiple displays. The apparatus includes two or more displays disposed within a vehicle cockpit, where the two or more displays include a first display and a second display. The content, in the form of an image, is displayed on the first display. The first display is disposed adjacent to the second display with a gap formed therein. One or more light emitting diodes (LEDs) are disposed within the gap and one or more lightguides are disposed adjacent to the LEDs and within the gap. The LEDs and lightguides are designed to emit or radiate light corresponding to the image such that the image appears to be blended between the displays when the image shifts between displays, and gives the illusion that the image moved from one display to the other.

### BACKGROUND

Vehicle cockpits typically consist of a single display in the middle of the dashboard for controlling various functions and features within the vehicle, and an instrument cluster with a second display located in front of the driver for viewing operational information of the vehicle as the driver is driving. However, advances in recent technology have allowed the option of using a display or multiple displays to make up a portion or the entirety of the dashboard for both the driver and passenger's use.

In an ideal situation, a single large display would make up a large portion or the entirety of the dashboard. Larger displays may be required; however, providing a singular display screen to cover the large area may be cost prohibitive and difficult to implement. As such, multiple displays are utilized. For instance, two or more displays positioned next to one another to form a larger display.

In using multiple displays, the displays may be set up in such a way that the images and content from one display flows to the other when necessary. Specifically, the displays have to be lined up perfectly next to one another with no gaps in between such that the content is proportional or symmetrical as it moves from one display to another. In other words, the displays have to be set up in such a way that the content does not appear to jump from one screen to another but instead gives the appearance of flowing effortlessly from one display to another. However, the particular shape of the dashboard may prohibit the displays from being aligned perfectly with no space or gap formed in between. As a result, the shape of the dashboard may require the displays to be angled such that a gap or space is formed. Even in such a configuration, visual symmetry between the displays as well as a way of hiding the edges of the display are desirable.

Thus, there is a need for an apparatus and method for transitioning content between multiple displays seamlessly where a gap exists therebetween for visual aesthetic of the driver and passengers.

### SUMMARY

An aspect of the present disclosure provides an apparatus and method for transitioning content between two or more displays within a vehicle.

An aspect of an apparatus for transitioning content between two or more displays within a vehicle includes the two or more displays positioned adjacent to one another with the vehicle such that a gap is formed there between, wherein the displays are configured to display the image, one or more light emitting diodes (LEDs) disposed within the gap between the two displays and being configured to emit light in a specific configuration corresponding to the image, and one or more lightguides disposed adjacent to the LEDs and within the gap between the two displays, wherein the lightguides are configured to disperse light from the LEDs in the specific configuration corresponding to the image such that the image appears to be blended between the two displays when the image transitions between the displays.

An aspect of an apparatus for transitioning content between two or more displays within a vehicle includes one or more lightguides disposed in a gap between the two displays, where the lightguides are configured to disperse light in a specific configuration corresponding to the image such that the image appears to be blended between the at least two displays when the image transitions between one display to the other.

An aspect of a method for transitioning an image between at least two displays using a lightguide disposed in a gap between the two displays within a vehicle includes displaying the image on one of the at least two displays, processing image transitioning via the electronic control unit; and transitioning the image by activating one or more light emitting diodes (LEDs) to emit light in a specific configuration corresponding to the image via the electronic control unit, where transitioning the imaging includes dispersing light from the LED in the specific configuration corresponding to the image using the lightguide such that the image appears to be blended between the two displays when the image transitions between the displays.

### BRIEF DESCRIPTION OF THE FIGURES

Other aspects of the present disclosure will be readily appreciated, as the same becomes better understood by reference to the following detailed description when considered in connection with the accompanying drawings where:

FIG. 1 is a block diagram of an apparatus for transitioning content between displays in a vehicle in accordance with an aspect of the present disclosure;

FIGS. 2A, 2B, and 2C are illustrations of various display and lens configurations of an apparatus for transitioning content between the displays in a vehicle in accordance with an aspect of the present disclosure;

FIGS. 3A and 3B are illustrations of various views of an apparatus for transitioning content between displays in a vehicle in accordance with an aspect of the present disclosure;

FIGS. 4A, 4B, and 4C are illustrations of an example of content transitioning between multiple displays in accordance with an aspect of the present disclosure;

FIG. 5 is a flowchart of a method of assembling an apparatus for transitioning content between multiple displays in accordance with an aspect of the present disclosure; and

FIG. 6 is of a method of transitioning content between multiple displays in accordance with an aspect of the present disclosure.

### DETAILED DESCRIPTION OF THE PRESENT DISCLOSURE

Detailed examples of the present disclosure are disclosed herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure. As those of ordinary skill in the art will understand, various features of the present disclosure are illustrated and described with reference to the Figures and may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

When a singular display cannot be used to cover a large area of a dashboard in a vehicle, multiple smaller displays can be used instead. However, problems exist with the use of multiple displays. For instances, gaps may exist between the displays if the shape of the dashboard does not allow the displays to line up with one another perfectly. Additionally, the displays may not be configured with the necessary control logic to allow content to travel from one display to another proportionally or seamlessly. As a result, content such as images or text may be displayed in a way that it appears to have jumped from one display to another, the content may be displaced between the two displays, or the only part of the content is displayed when the content pass from one display to the other due to the gap.

To solve this problem, the present disclosure employs one or more lightguides and one or more light emitting diodes (LEDs) that are configured to reflect the content and fill in the gap so that the content appears whole and appears as if the content moves seamlessly from one display to the other. Additionally, the present disclosure employs control logic that is designed to transition the content proportionally from one display to the other.

The aspects of the present disclosure include an apparatus and method for transitioning content between multiple displays having two or more displays being positioned adjacent to one another such that a gap is formed therebetween. The two or more displays each have a front portion that faces the user of the vehicle and the displays are configured to display an image representative of the content. The apparatus has one or more light emitting diodes (LEDs) disposed within the gap between the two displays, and one or more lightguides disposed adjacent the LEDs and within the gap between the two displays. The apparatus further includes one or more lens affixed to each of the front portions of the two displays such that the lens cover each of the front portions of the two displays, the LEDs, and the lightguides. In operation, the LEDs emit light based on tor corresponding to the content transitioning between the displays and the lightguide disperses the light from the LED and from the display such that the image appears to be blended between the two displays and gives the illusion that the image is moving from one display to another.

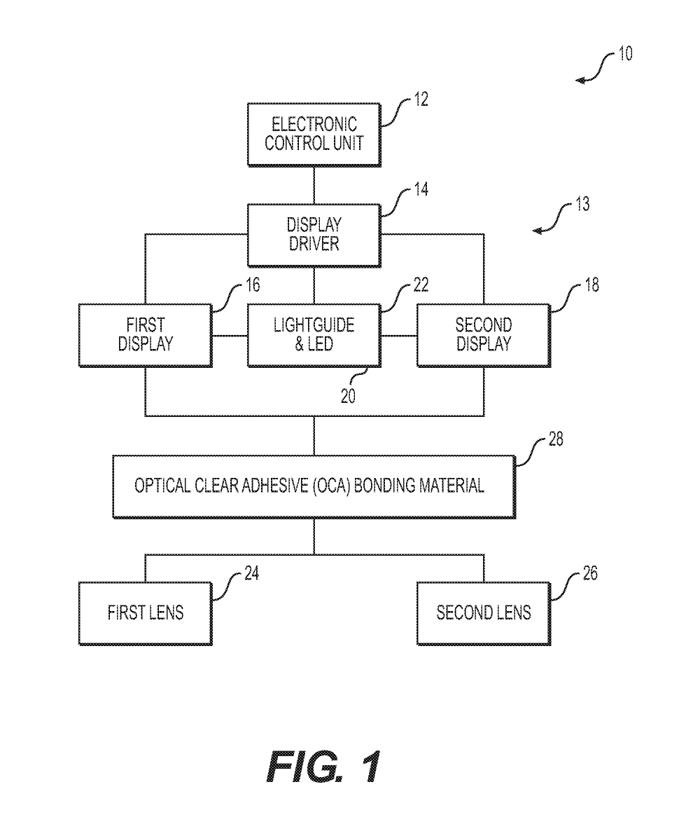

FIG. 1 is a block diagram of an apparatus 10 for transitioning content between displays 16, 18 in a vehicle in accordance with an aspect of the present disclosure. The apparatus 10 includes an electronic control unit 12, a display driver 14 connected to the electronic control unit 12, one or more displays 16, 18 connected to the display driver 14 and disposed adjacent to one another with a gap formed therebetween, one or more light emitting diodes (LEDs) 20 and one or more lightguides 22 disposed in the gap between the displays 16, 18, and one or more lens 24, 26 affixed to the front of the displays 16, 18 via one or more layers of optical clear adhesive (OCA) bonding material 28. The display driver 14, displays 16 and 18, LEDs 20, lightguides 22, and lens 24, 26 forms the display module 13.

The electronic control unit 12 has a controller (not shown) with hardware and/or software control logic for operating various modules within the vehicle and any combination of memory storage such as random-access memory (RAM) and/or read-only memory. The electronic control unit 12 may be wired or wirelessly connected to the display driver 14. The electronic control unit 12 has control logic for controlling content, such as images including pictures, icons, or texts, for display on the first display 16 and second display 18. The electronic control unit 12 controls two or more displays 16, 18 such as a first display 16 and a second display 18, one or more LEDs 20, and one or more lightguides 22 through a display driver 14. The display driver 14 may be wired or wirelessly connected to the first display 16, second display 18, LEDs 20, and lightguide 22. The first display 16 is disposed adjacent to the second display 18 with a gap formed therebetween. The apparatus 10 may also include a third display (not shown) adjacent to the second display 18 with a second gap formed therebetween. Each display 16, 18 may have a LCD screen and each display 16, 18 may be angled in different directions for viewing by the driver and passenger in the vehicle.

One or more lens 24, 26 are affixed to the two or more displays 16, 18 through one or more layers of optical clear adhesive (OCA) bonding material 28. The one or more lens 24, 26 may include an individual lens for each display. For example, there may be a first lens 24 affixed to the first display 16, a second lens 26 affixed to the second display 18 and a third lens (not shown) affixed to a third display (not shown). The first lens 24 has a curvature in a first direction, the second lens 26 may have a curvature in the same direction or a different as the first lens 24, and the third lens may have a curvature in the same direction or a different direction as the first or second lens 24, 26. For instance, the first lens 24 and the third lens may both have curvatures that are concave, and the second lens may have a curvature that is convex. Alternatively, the curvature of the first and third lens may be convex while the curvature of the second lens is concave. The curvatures are designed to change the depth of the content on the displays 16, 18. In other words, the content or image may appear closer to or farther away from the driver or passengers based on the curvature of the lens. The one or more lens 24, 26 may have a touch surface such that the driver or passenger can select features on the displays 14, 16. As discussed previously, the lens 24, 26 are affixed to the displays 16, 18 via one or more layers of OCA bonding material 28. The OCA bonding material 28 may be liquid OCA bonding material. Additionally, the OCA may be disposed between the lens 24, 26 and the displays 16 and 18, or may be disposed only on a portion of the lens 24 and 26, and the display 16, 18. Similar to the curvatures of the lens 24 and 26, the one or more layers of OCA 28 may change the depth of the content or image on the display when viewed.

In operation, the electronic control unit 12 generates the content or image for display, determines the location on the display 16 where the image is displayed, determines when to activate image transitioning and may further process image transitioning when ready. Processing the image may include determining what the image is and which of the LEDs 20 will have to be activated to emit light during image transitioning. After image transitioning is processed, the image may transition between the two displays when the electronic control unit activates one or more LEDs 20 to emit light in a specific configuration corresponding to the image. Transitioning the image includes dispersing light from the LEDs in the specific configuration corresponding to the image using one or more lightguides such that the image appears to be blended between the two displays. As a result, the image appears to seamless transition from one display to another.

In another aspect of the present disclosure, the display module 13 may be connected to a gaze tracking and control module (not shown) that is configured to detected the driver's gaze and select features on the displays 16 and 18 based on the driver's gaze. Additionally, the display module 13 may also be connected to a gesture control module (not shown) that is configured to allow the driver or passenger to select and operate features on the display through physical gestures.

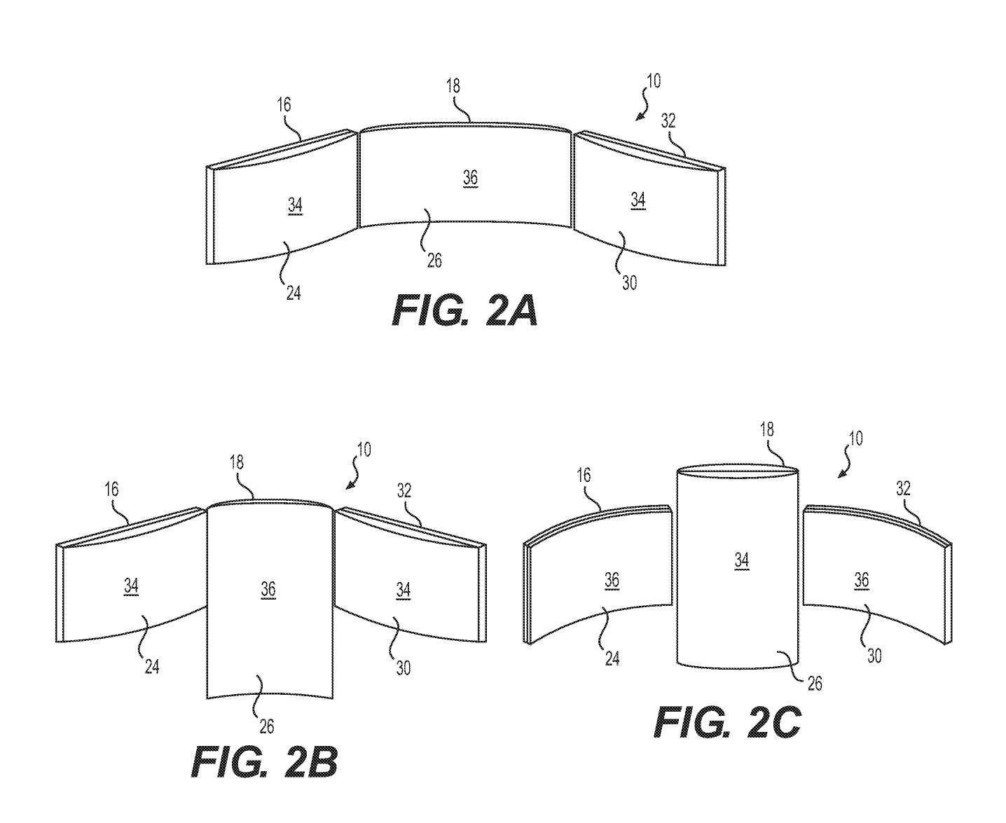

FIGS. 2A, 2B, and 2C are illustrations of various configurations displays and lens of an apparatus 10 for transitioning content between displays in accordance with an aspect of the present disclosure. Specifically, FIG. 2A shows a first, second, and third lens 24, 26, and 30 affixed to a first, second, and third display 16, 18, and 32, respectively. The lens 24, 26, 30 are affixed through OCA bonding material (not shown). The first lens 24 and the third lens 30 both have a convex curvature 34 and the second lens 26 has a concave curvature 36. The displays 16, 18, and 32 in FIG. 2A are all positioned horizontally. However, it is understood that the displays 16, 18, and 32 could be positioned horizontally, vertically, or in a combination thereof. As shown in FIGS. 2B and 2C, the first and third displays 16, 32, and the first and third lens 24, 30, are positioned horizontally while the second display 18 and the second lens 26 is positioned vertically. FIG. 2B shows the first and third lens 24, 30 with a concave curvature 34 and the second lens 26 with a convex curvature 36. FIG. 2C shows the first and third lens 24, 30 with a convex curvature 36 and the second lens 26 with a concave curvature 34. Each curvature 34, 36 is designed to change the depth of the content or image displayed on the display 16, 18 and lens 24, 26. However, it is not intended that these examples of curvatures illustrate and describe all possible forms or configurations of the lens 26. Instead, it is understood that the lens 26 are not limited to the examples above and other configurations different curvatures may be formed within the lens 26, which still results in a change in depth of the content when viewed.

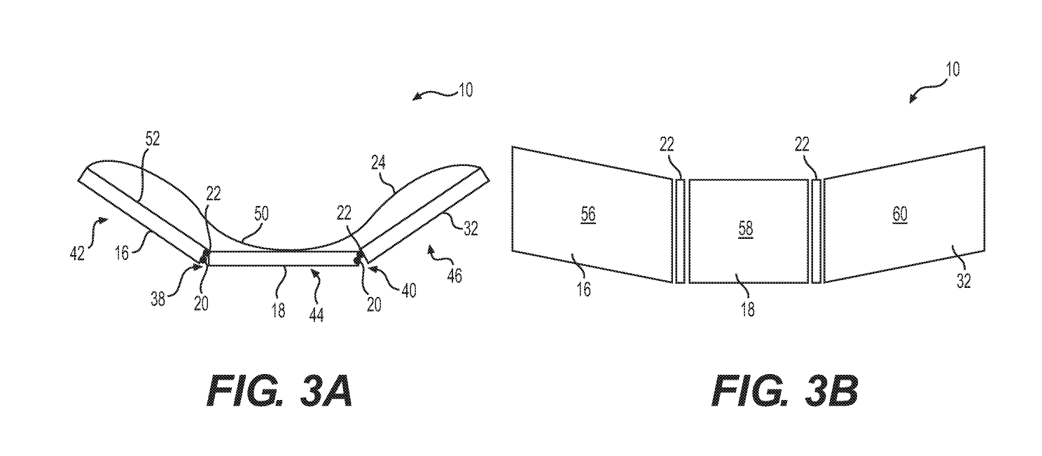

FIGS. 3A and 3B are illustrations of various views of an apparatus 10 for transitioning content between displays in accordance with an aspect of the present disclosure. In particular, FIG. 3A shows a top view of the apparatus 10. The apparatus 10 of FIG. 3A includes a first display 16, a second display 18, and a third display 32, where the first display 16 is adjacent to the second display 18 and has a first gap 38 formed therebetween, and the second display 18 is adjacent to the third display 32 and has a second gap 40 formed therebetween. The first display 16 is angled in a first direction 42, the second display 18 is angled in a second direction 44 different from the first direction 42 of the first display 16, and the third display 32 is angled in a third direction 46 different from the first and second directions 42, 44 of the first and second displays 16, 18. For instance, the first display 16 may be angled towards the driver and the third display 32 may be angled towards the passenger for use and visual aesthetics. The second display 18 may be angled towards both the driver and passenger. One or more lightguides 22 and LEDs 20 are disposed in the first and second gaps 38, 40. The lightguides 22 and LEDs 20 are used to hide or de-emphasize the edges of the displays 16, 18, and 32. The lens 24, 26 having one or more curvatures 50 are affixed to the front portion 52 of the displays 16, 18, and 32 via OCA bonding material (not shown).

FIG. 3B is a forward-facing view of the apparatus 10. Like FIG. 3A, FIG. 3B shows the first, second, and third displays 16, 18, and 32. Specifically, FIG. 3B is divided into one or more zones including a first zone 56 corresponding to the first display 16 angled towards the driver, a second zone 58 corresponding to the second display 18 angled towards both the driver and passenger (i.e. the second zone is a shared zone), and a third zone 60 corresponding to the third display 32 angled towards the passenger. The zones may allow the driver or passenger to control the zone corresponding to them. The first, second, and third displays 16, 18, 32 are disposed adjacent to one another within the vehicle cockpit (not shown). Two lightguides 22 are disposed in between the displays 16, 18, and 32 and are configured to disperse light from LEDs (not shown) and from the edges of the displays corresponding to the content or image transitioning between the displays such that it gives the illusion that content is moving between the displays and that the image or content appears to be blended between the displays 16, 18. The lens are not shown in FIG. 3B.

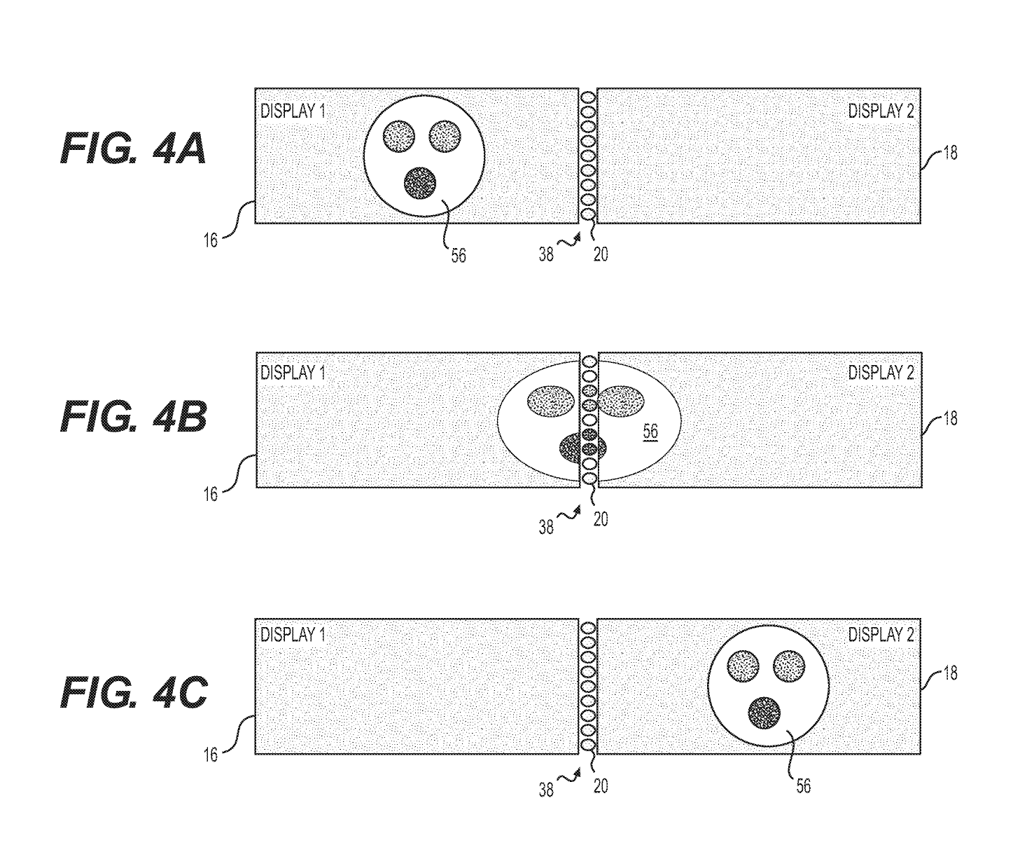

FIGS. 4A, 4B, and 4C are illustrations of an example of content or image 56 transitioning between multiple displays in accordance with an aspect of the present disclosure. In particular, FIG. 4A shows a first display 16 and a second display 18 adjacent to one another and with a gap 38 formed therebetween. An array of LEDs 20 is disposed within the gap 38. Content in the form of an image 56, for instance a face, is shown on the first display 16. When the apparatus 10 of FIG. 4B, and specifically, the electronic control unit (not shown) determines and instructs that the image 56 to shift, move, or transition from the first display 16 to the second display 18, the electronic control unit activates the LED lights 20 which emits light corresponding to the image 56 such that the image 56 appears to be blended between the two displays 16 and 18, and gives the illusion that the image 56 is moving from one display to another. The gap 38 between and edges of the displays are de-emphasized and are virtually symmetric to the driver and passenger so that the image 56 does not appear to jump between the displays 16, 18. The image 56 is then shown on the second display 18 after the image 58 has transitioned to the second display 18, as shown in FIG. 4C.

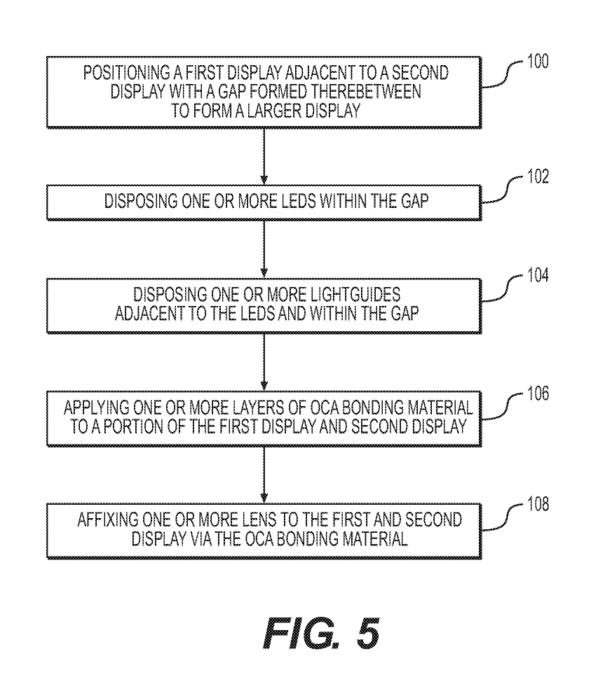

FIG. 5 is a flowchart of a method for assembling an apparatus for transitioning content between multiple displays as described above in FIGS. 1-4. The method includes positioning a first display adjacent to a second display with a gap formed therebetween to form a larger display 100. A third display may also be included in forming the larger display, where a second gap is formed between the second display and the third display. Once the displays are positioned to form the larger display 100, one or more LEDs are disposed within the gap 102. The one or more LEDs may be a plurality of LEDs configured to emit light in a certain configuration corresponding to the content or image for translation between the displays.

One or more lightguides are also disposed adjacent to the LEDs and within the gap between the first and second displays 104. The one or more lightguides may be a plurality of lightguides which are designed to disperse light from the LEDs in the certain configuration such that the image appears to be blended between the two displays during content translation.

One or more layers of OCA bonding material are applied to a portion of one of the first and second displays 106. The layers of OCA may be used to visually change the depth of the content or image displayed on either or both of the displays. Once the OCA bonding material is applied 106, one or more lens are affixed to the first and second displays via the OCA bonding material 108. The lens may include a first lens affixed to the first display and a second lens affixed to the second display. The first lens may have a curvature in a first direction designed to change the depth of the image on the display. Additionally, the second lens may have a curvature in a second direction different from the first lens also designed to change the depth of the image on the display.

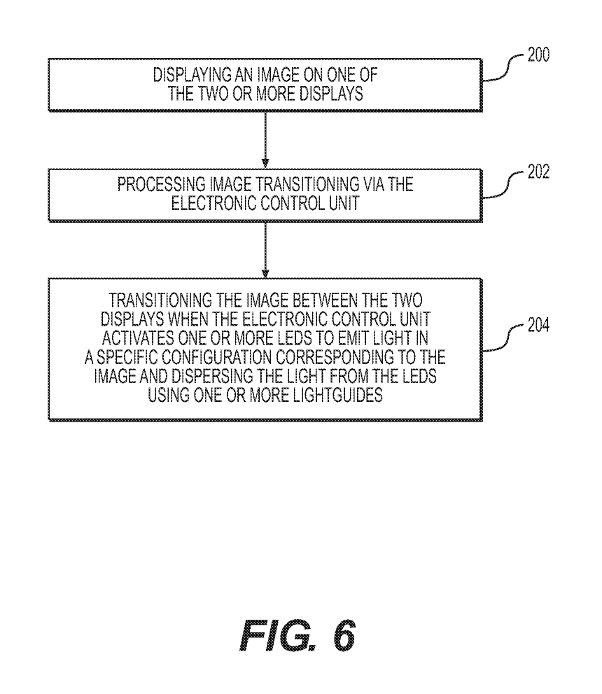

FIG. 6 is a flowchart of a method of transitioning content between multiple displays in accordance with the present disclosure. The method utilizes the apparatus as described in FIGS. 1-5. The method includes displaying an image on one of the two or more displays 100. Once an image is displayed 100, the electronic control unit may determine when to activate image transitioning and may further process image transitioning when ready 102. Processing the image may include determining what is image is and which LEDs will have to be activated to emit light during image transitioning. After imaging transitioning is processed 102, the image may transition between the two displays when the electronic control unit activates one or more LEDs to emit light in a specific configuration corresponding to the image 104. Transitioning the image includes dispersing light from the LEDs in the specific configuration corresponding to the image using one or more lightguides such that the image appears to be blended between the two displays. As a result, the image appears to seamless transition from one display to another.

While examples of the disclosure have been illustrated and described, it is not intended that these examples illustrate and describe all possible forms of the disclosure. Rather, the words used in the specification are words of description rather than limitation, and it is understood that various changes may be made without departing from the spirit and scope of the disclosure. Additionally, the features and various implementing aspects may be combined to form further examples of the disclosure.

We claim:

1. An apparatus to transition an image between at least two displays with a vehicle, comprising:
the at least two displays positioned adjacent to one another with the vehicle such that a gap is formed there between, wherein the displays are configured to display the image;
at least one light emitting diode (LED) disposed within the gap between the at least two displays and being configured to emit light in a specific configuration corresponding to the image; and
at least one lightguide disposed adjacent to the at least one LED and within the gap between the at least two displays,
wherein the lightguide is configured to disperse light from the LED in the specific configuration response to the image transitioning between one display to the other.

2. The apparatus of claim 1, further including:
an electronic control unit configured to process transitioning of the image between the at least two displays and to implement transitioning of the image between the two displays by activating the at least one LED to emit light in the specific configuration corresponding to the image.

3. The apparatus of claim 1, wherein the at least two displays include a first display and a second display.

4. The apparatus of claim 3, wherein the at least two displays include a third display disposed adjacent to the second display forming a second gap therebetween, and wherein the at least one LED and the at least one lightguide are disposed within the second gap.

5. The apparatus of claim 4, wherein the first display, the second display, and the third display form a first zone, a second zone, and a third zone.

6. The apparatus of claim 5, wherein the first zone displays driver-based content, the second zone displays shared content, and the third zone displays passenger-based content.

7. The apparatus of claim 1, further comprising:
at least one layer of optical clear adhesive (OCA) bonding material disposed on a portion of one of the at least two displays.

8. The apparatus of claim 7, wherein the OCA bonding material is liquid OCA bonding material.

9. The apparatus of claim 7, wherein the at least one layer of OCA bonding material is a plurality of layers of OCA bonding material for visually changing the depth of the image on a portion of one of the at least two displays.

10. The apparatus of claim 7, further comprising:
at least one lens affixed to a portion of the at least two displays via the OCA bonding material.

11. The apparatus of claim 10, wherein the at least one lens has a curvature configured to change the depth of the image on one of the at least two displays.

12. The apparatus of claim 10, wherein the at least one lens is a first lens affixed to the first display and a second lens affixed to the second,
wherein the first lens has a first curvature in a first direction and the second lens has a second curvature in a second direction different from the first curvature.

13. An apparatus to transition an image between at least two displays within a vehicle, comprising:
at least one lightguide disposed in a gap between the at least two displays,
wherein the lightguide is configured to disperse light in a specific configuration in response to the image transitioning between one display to the other.

14. The apparatus of claim 13, wherein the at least one lightguide is a plurality of lightguides.

15. The apparatus of claim 13, further comprising:
an array of light emitting diodes (LEDs) for emitting the light in a specific configuration corresponding to the image.

16. The apparatus of claim 15, further comprising:
an electronic control unit configured to process image transitioning between the at least two displays and to implement transitioning of the image between the two displays by activating the at least one LED to emit light in the specific configuration corresponding to the image.

17. A method for transitioning an image between at least two displays using a lightguide disposed in a gap between the two displays within a vehicle, comprising:
displaying the image on one of the at least two displays;
processing image transitioning via the electronic control unit; and
transitioning the image by activating at least one light emitting diode (LED) to emit light in a specific configuration corresponding to the image via the electronic control unit,
wherein transitioning the imaging includes dispersing light from the LED in the specific configuration when the image transitions between the displays.
